(19) United States
(12) Patent Application Publication
(10) Pub. No.: US 2013/0258237 A1
(43) Pub. Date: Oct. 3, 2013

(54) Manufacturing Method of LCD Device and LCD Device

(71) Applicant: Yanxue Zhang, Shenzhen (CN)

(72) Inventor: Yanxue Zhang, Shenzhen (CN)

(21) Appl. No.: 13/503,850

(22) PCT Filed: Mar. 31, 2012
(86) PCT No.: PCT/CN12/73384

§ 371 Date: Apr. 24, 2012

(30) Foreign Application Priority Data
Mar. 29, 2012 (CN) 201210087529.2

(51) Int. Cl. G02F 1/1333; B29C 45/26

(52) U.S. Cl. 349/60; 264/219

(57) ABSTRACT

The invention provides a manufacturing method of an LCD device and an LCD device. The manufacturing method of an LCD device includes a manufacturing method of a front frame and a rubber frame: designing the patterns of a plate-shaped front frame and a rubber frame in the same mold; injection molding in the mold, and forming the front frame and the rubber frame after demolding. Because the degree of freedom of the LCD panel of the invention is fixed by the rubber frame in the plane direction and is clamped and fixed by the front frame and the rubber frame in the direction perpendicular to the LCD panel, and the front frame is in a plate shape, the LCD panel is only positioned by the front frame in the direction (Z axis direction) perpendicular to the LCD panel, and is positioned by the rubber frame in other directions. Thus, the structure of the front frame is greatly simplified, and the opening mold cost of the front frame is reduced; further, the front frame and the rubber frame can be molded by the same mold, thereby lowering the mold cost; in addition, the front frame and the rubber frame can be simultaneously produced by one injection molding, favoring the improvement of production efficiency and the reduction of production cost.

### TECHNICAL FIELD

The invention relates to the field of liquid crystal displays (LCDs), and more particularly to a manufacturing method of an LCD device and an LCD device.

### BACKGROUND

An LCD device includes a front frame, and a backplane; the front frame is positioned on the outermost layer of the LCD device, and the backplane is positioned on the back of the device; the backplane is used for supporting the components inside a backlight module of the LCD device, and matched with the front frame to form a shell of the whole LCD device; in general, the LCD device is internally provided with a rubber frame which is used for isolating the backlight module from an LCD panel. Conventional LCD devices in mass production generally employ a front frame to fix the panel, and usually employ integrated design (as shown in FIG. 1-2) or support design (as shown in FIG. 3-4); both the two designs require to separately develop molds.

As shown in FIG. 5-6, a conventional LCD device includes a metal front frame 10; a flexible spacer 13 is arranged between the metal front frame and an LCD panel 40, a rubber frame 20 is arranged between the LCD panel 40 and a light guide panel 50, the contact surface between the rubber frame 20 and the LCD panel 40 is also provided with a flexible spacer 13, and the metal front frame 10, the rubber frame 20, and a backplane 30 are fixed on the side surface of the LCD device.

Disadvantages of the aforementioned conventional LCD device are summarized below: 1. the mold cost of the front frame is high; 2. both the material cost and manpower cost are high.

### SUMMARY

In view of the above-described technical problems, the aim of the invention is to provide a manufacturing method of an LCD device and an LCD device of low cost.

The aim of the invention is achieved by the following technical schemes.

A manufacturing method of an LCD device includes a manufacturing method of a front frame and a rubber frame.

A: Designing the patterns of a plate-shaped front frame and a rubber frame in the same mold; and

B: Injection molding in the mold, and forming the front frame and the rubber frame after demolding.

Preferably, the pattern of the front frame comprises a pattern of four independent subordinate front frames, and a pattern of a joining structure of a rectangle front frame formed by the four subordinate front frames end to end. By using the mode of joining the subordinate front frames, the structure of the front frame can be simplified, the subordinate front frames can be respectively taken out when demolding, and the difficulty of demolding can be reduced.

Preferably, the pattern of the rubber frame is of a pattern structure which is integratedly molded. The integratedly molded pattern of the rubber frame can simplify the subsequent installation step of the front frame, and the connection strength of the front frame can be high.

An LCD device comprises a front frame, and a rubber frame; an LCD panel is clamped between the front frame and the rubber frame, and the LCD panel is fixed by the rubber frame in the direction parallel to the light emitting surface thereof, and is clamped and fixed by the front frame and the rubber frame in the direction perpendicular to the light emitting surface thereof; the front frame is in a plate shape.

Preferably, the front frame comprises four independent subordinate front frames, and the four subordinate front frames form a rectangle front frame end to end. By using the mode of joining the subordinate front frames, the structure of the front frame can be simplified, the subordinate front frames can be respectively taken out when demolding, and the difficulty of demolding can be reduced.

Preferably, the rubber frame is of a structure which is integratedly molded. The integratedly molded structure can simplify the subsequent installation step of the front frame, and the connection strength of the front frame can be high.

Preferably, the edge of the front frame is positioned inside the top of the rubber frame, and the top of the rubber frame is flush with the outer surface of the front frame, thereby increasing the surface planeness of the LCD device.

Preferably, the front frame and the rubber frame are made of the same material. Using the same material favors common mold production, saves mold cost, and increases production efficiency.

Preferably, the LCD device comprises a backplane; the backplane is provided with a folding surface in the direction of the front frame, and the front frame, the rubber frame and the folding surface of the backplane are fixed by a screw; and the outer surface of the front frame is provided with a sinking surface in the fixing position of the screw. The backplane, the rubber frame and the front frame are stacked together at one surface of the fixing structure of the backplane, the rubber frame and the front frame, and the backplane, the rubber frame and the front frame are simultaneously fixed by one screw; thus, the installation efficiency is high. After fixing the screw, the head of the screw is higher than the fixing surface thereof, and the surface of the head of the screw is basically flush with the outer surface of the whole front frame after the sinking surface is arranged, thereby increasing the planeness.

Preferably, the inner surface of the front frame facing the LCD panel is provided with an inner sinking surface. The inner sinking surface can avoid the circuit at the edge of the LCD panel, thereby avoiding the short circuit caused by the contact between a conducting film and the circuit.

Because the degree freedom of the LCD panel of the invention is fixed by the rubber frame in the plane direction and is clamped and fixed by the front frame and the rubber frame in the direction perpendicular to the LCD panel, and the front frame is in a plate shape, the LCD panel is only positioned by the front frame in the direction (Z axis direction) perpendicular to the LCD panel, and is positioned by the rubber frame in other directions. Thus, the structure of the front frame is greatly simplified, and the opening mold cost of the front frame is reduced; further, the front frame and the rubber frame can be molded by the same mold, thereby lowering the mold cost; in addition, the front frame and the rubber frame can be simultaneously produced by one injection molding, favoring the improvement of production efficiency and the reduction of production cost.

### BRIEF DESCRIPTION OF FIGURES

FIG. 1 is an assembly diagram of a conventional integrated front frame;

FIG. 2 is a front view of a conventional integrated front frame;

FIG. 3 is an assembly diagram of a conventional support front frame;

FIG. 4 is a schematic diagram of a conventional support front frame;

FIG. 5 is a schematic diagram of a conventional LCD device;

FIG. 6 is a partial sectional view of FIG. 5;

FIG. 7 is a schematic diagram of a common mode of a rubber frame and a front frame;

FIG. 8 is a structure diagram of the invention;

FIG. 9 is a partial enlarged view of the invention;

FIG. 10 is a three-dimensional view of a structure section of the invention; and

FIG. 11 is a plane view of a structure section of the invention.

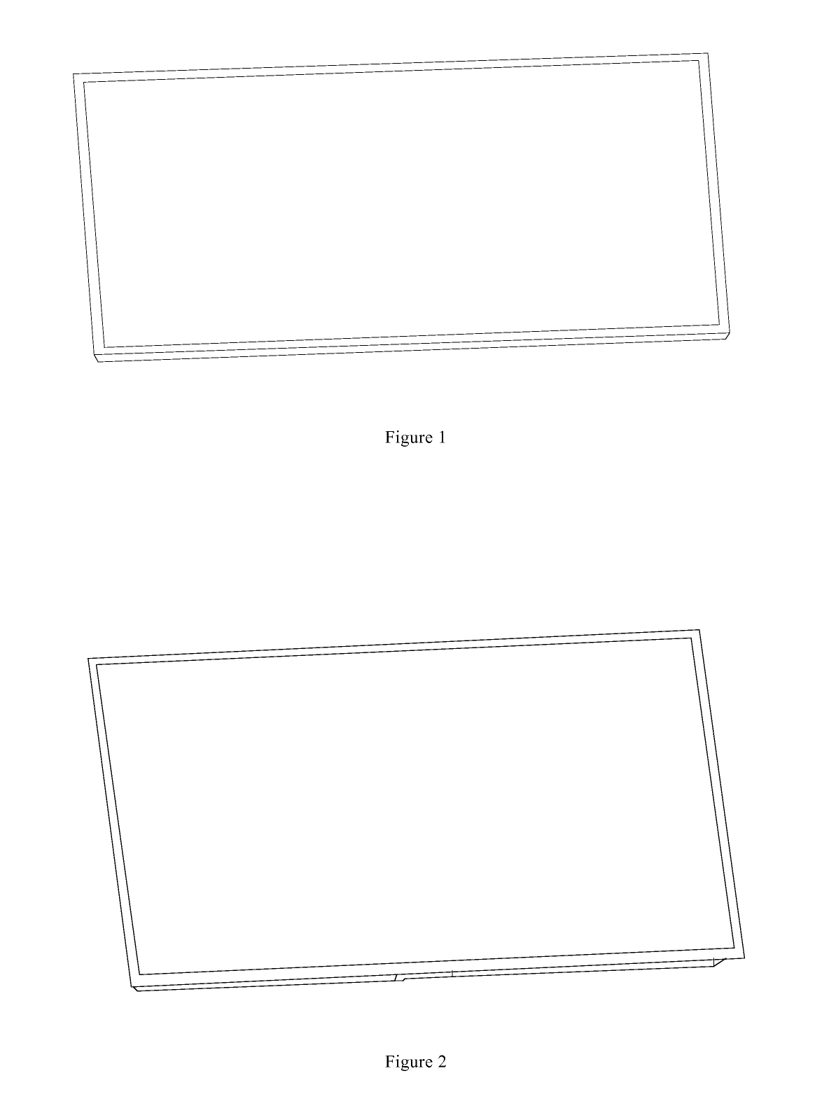

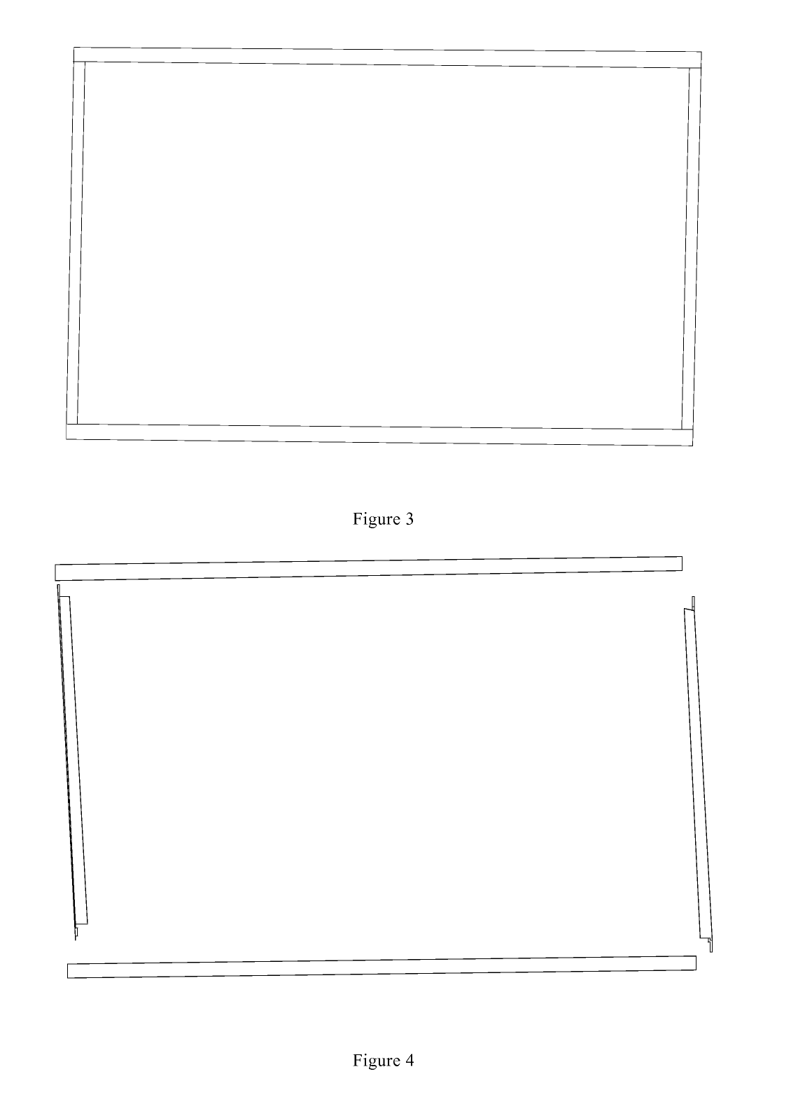

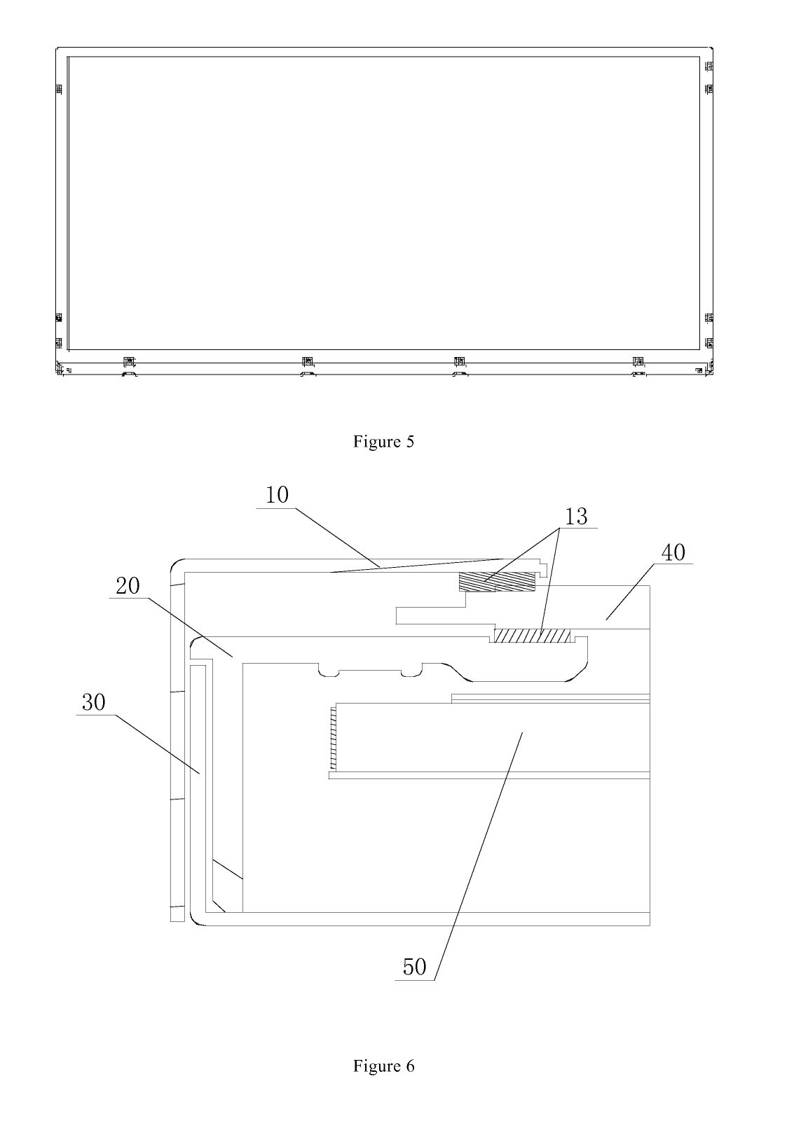

Legends: 100. front frame; 110. inner sinking surface; 120. conducting film; 130 sinking surface; 140. subordinate front frame; 200. rubber frame; 220. opening; 300. backplane; 310. clamping hook; 320. folding surface; 400. LCD panel; 500. light guide panel; 600. screw.

### DETAILED DESCRIPTION

The invention will further be described in detail in accordance with the figures and the preferred examples.

A manufacturing method of an LCD device comprises a manufacturing method of a front frame 100 and a rubber frame 200:

A: Designing the patterns of a plate-shaped front frame 100 and a rubber frame 200 in the same mold; and

B: Injection molding in the mold, and forming the front frame 100 and the rubber frame 200 after demolding.

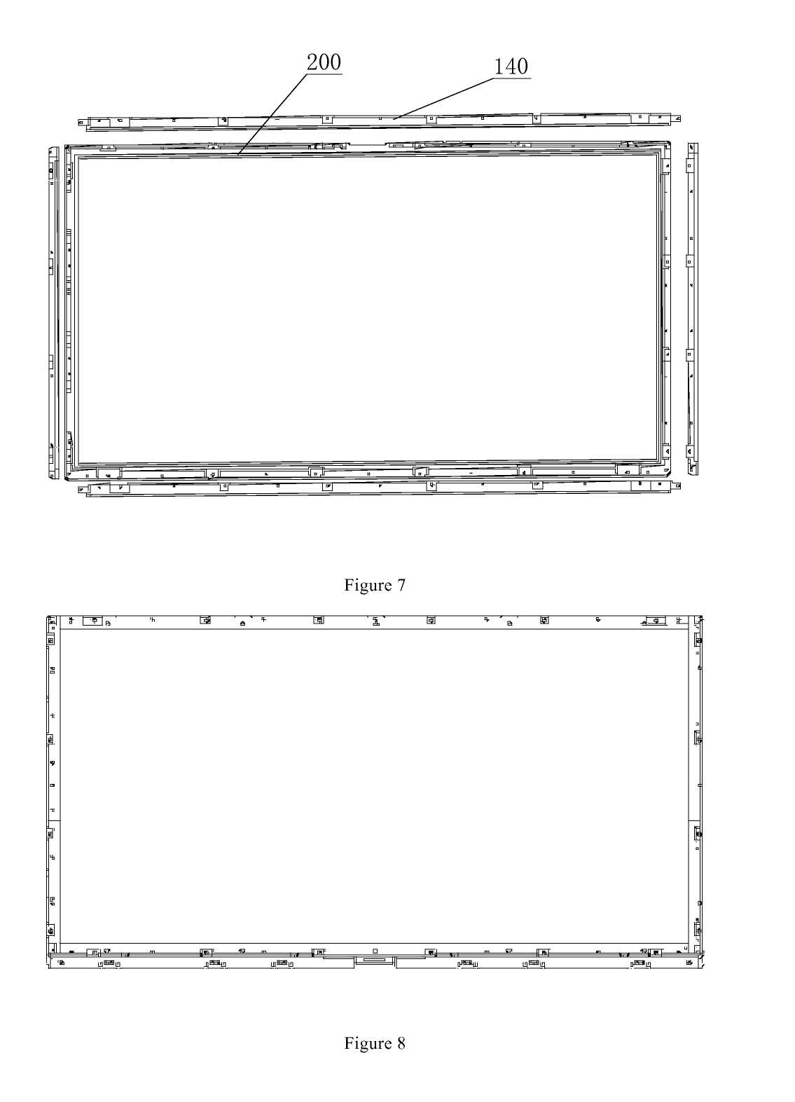

As shown in FIG. 7, the pattern of the front frame comprises a pattern of four independent subordinate front frames, and a pattern of the joining structure of a rectangle front frame formed by the four subordinate front frames end to end. By using the mode of joining the subordinate front frames, the structure of the front frame can be simplified, the subordinate front frames can be respectively taken out when demolding, and the difficulty of demolding can be reduced. The pattern of the rubber frame is of a pattern structure which is integratedly molded. The integratedly molded structure can simplify the subsequent installation step of the front frame, and the connection strength of the front frame can be high. Optionally, the rubber frame can be of the structure of joining multiple subordinate rubber frames by a sectioning mode, to simplify structure and facilitate demolding.

Because the front frame 100 of the conventional LCD device is complicated, the front frame 100 and the middle frame are processed by three molds in total. The design of the simplified front frame 100 is employed by the invention, so that the middle frame and the front frame 100 can be simultaneously molded in one mold.

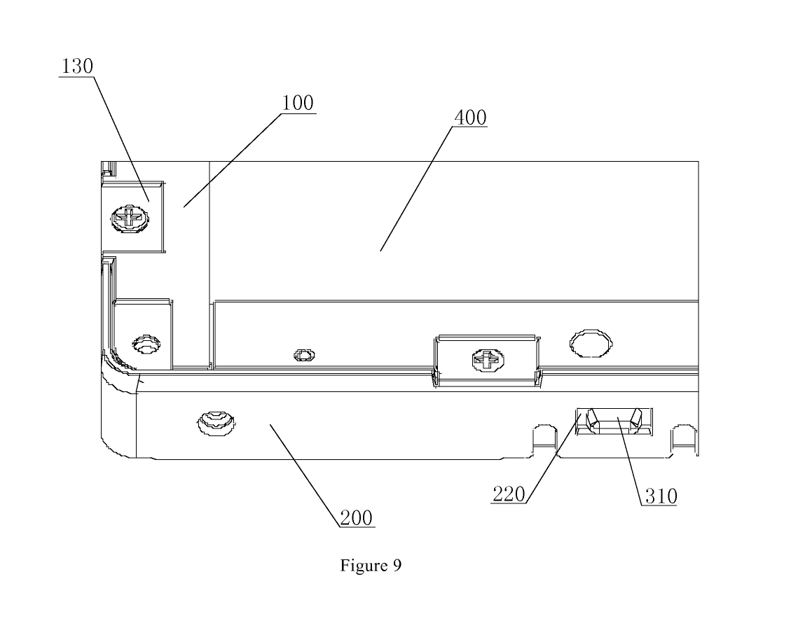

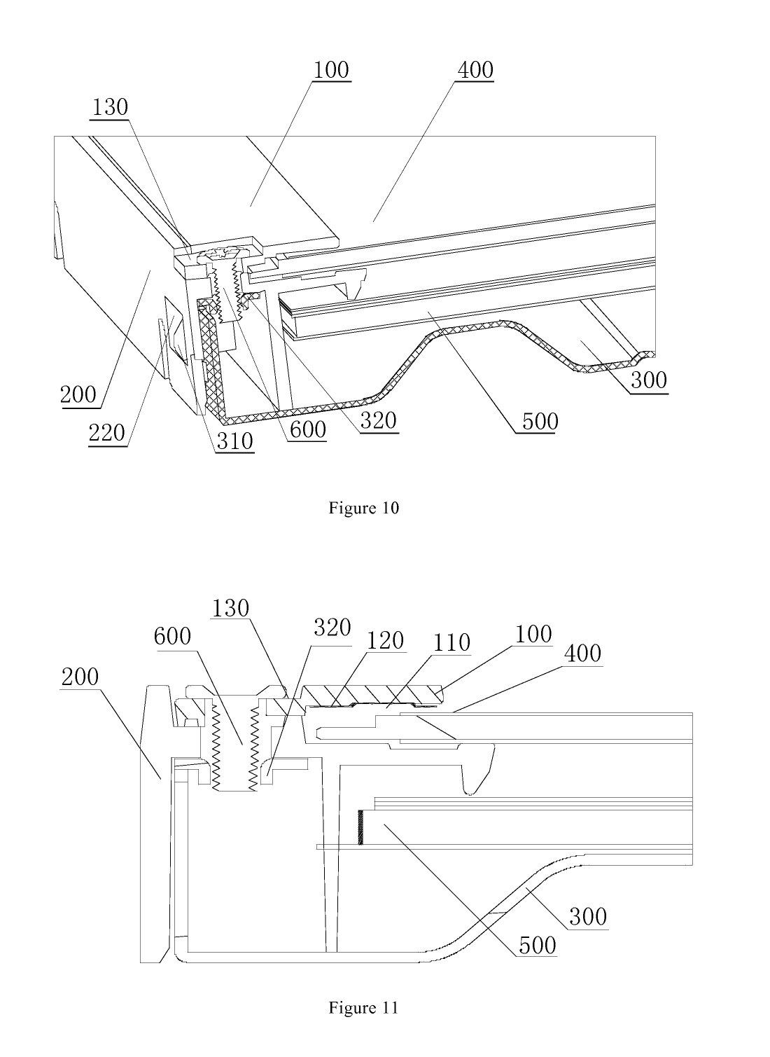

As shown in FIG. 7-11, an LCD device comprises a front frame 100 manufactured by using the aforementioned method, a rubber frame 200, and a backplane 300; an LCD panel 400 is clamped between the front frame 100 and the rubber frame 200; the degree of freedom of the LCD panel 400 is fixed by the rubber frame 200 in the plane direction and is clamped and fixed by the front frame 100 and the rubber frame 200 in the direction perpendicular to the LCD panel 400; the front frame 100 is in a plate shape; the edge of the front frame 100 is positioned inside the top of the rubber frame 200, the inside of the top of the rubber frame 200 is butted with the side surface of the front frame 100, and the top of the rubber frame 200 is flush with the outer surface of the front frame 100. The front frame comprises four independent subordinate front frames 140, and the four subordinate front frames 140 form a rectangle front frame end to end. By using the mode of joining the subordinate front frames 140, the structure of the front frame can be simplified, the subordinate front frames 140 can be respectively taken out when demolding, and the difficulty of demolding can be reduced. The rubber frame is of a structure which is integratedly molded. The integratedly molded structure can simplify the subsequent installation step of the front frame, and the connection strength of the front frame can be high. Optionally, the rubber frame can be of the structure of joining multiple subordinate rubber frames by a sectioning mode, to simplify structure and facilitate demolding.

The aforementioned front frame 100 is not provided with a folding edge but is only provided with a plate-shaped surface fixed to the top of the rubber frame 200. Thus, the structure of the front frame 100 can be further simplified, the cost can be reduced, and the surface planeness of the LCD device can be increased because the top of the rubber frame 200 is flush with the outer surface of the front frame 100. Optionally, the front frame 100 can be provided with a folding edge to cover the top of the rubber frame 200, and can be fixed to the rubber frame 200 at the side of the rubber frame 200.

The LCD device comprises a backplane 300; a light guide panel 500 is supported in the backplane 300, the side wall of the backplane 300 is provided with a clamping hook 310, and correspondingly, the side wall of the rubber frame 200 is provided with an opening 220 which is matched with the clamping hook 310. The matching of the clamping hook 310 and the opening 220 facilitates the fixation of the backplane 300, and also facilitates the removal of the backplane 300. The backplane 300 is provided with a folding surface 320 in the direction of the front frame 100, thus, the backplane 300, the rubber frame 200 and the front frame 100 are stacked together at one surface of the fixing structure of the backplane 300, the rubber frame 200 and the front frame 100, and the backplane 300, the rubber frame 200 and the front frame 100 are simultaneously fixed by one screw 600; therefore, the installation efficiency is high. Optionally, the components can be fixed by sticking, welding, riveting and the like.

After fixing the screw 600, because the head of the screw 600 is higher than the fixing surface thereof, the outer surface of the front frame 100 can be provided with a sinking surface 130 corresponding to the fixing position of the screw 600. After the sinking surface 130 is arranged, the surface of the head of the screw 600 is basically flush with the outer surface of the whole front frame 100, thereby increasing the planeness.

One side of the front frame 100 clamping the LCD panel 400 is further provided with a conducting film 120, and the conducting film 120 is electrically connected with the backplane 300 by a bolt, to conduct the static electricity generated on the surface of the LCD panel 400 onto the metal backplane 300 behind the device, thereby increasing the reliability of the LCD panel 400. The inner surface of the front frame 100 facing the LCD panel 400 is provided with an inner sinking surface 110 which can avoid the circuit at the edge of the LCD panel 400, thereby avoiding the short circuit caused by the contact between the conducting film 120 and the circuit.

To save the number of molds and reduce mold cost, the front frame 100 and the rubber frame 200 can be made of the same material.

The front frame 100 of the invention only fixes the degree of freedom of the LCD panel 400 in the Z axis direction, achieving the purposes of fixing the LCD panel 400 and simplifying the design of the front frame 100 to a great extent. Based on the design, the front frame 100 and the rubber frame 200 can be injection molded by using the same plastic material, achieving the purposes of fixing the LCD panel 400 and injection molding the front frame 100 and the rubber frame 200 by using the same mold; thus, the purposes of simplifying product design and reducing the cost of molds and product material can be achieved.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

1. A manufacturing method of an LCD device, comprising: a manufacturing method of a front frame and a rubber frame:
A: designing the patterns of a plate-shaped front frame and a rubber frame in the same mold; said front frame pattern comprises a pattern of four independent subordinate front frames, and a pattern of a joining structure of a rectangle front frame formed by said four subordinate front frames end to end; the pattern of said rubber frame is of a pattern structure which is integratedly molded. B: injection molding in said mold, and forming said front frame and said rubber frame after demolding.

2. A manufacturing method of an LCD device, comprising: a manufacturing method of a front frame and a rubber frame:
A: designing the patterns of a plate-shaped front frame and a rubber frame in the same mold;
B: injection molding in said mold, and forming said front frame and said rubber frame after demolding.

3. The manufacturing method of an LCD device of claim 2, wherein the pattern of said front frame comprises a pattern of four independent subordinate front frames, and a pattern of the joining structure of a rectangle front frame formed by said four subordinate front frames end to end.

4. The manufacturing method of an LCD device of claim 2, wherein said rubber frame is of a pattern structure which is integratedly molded.

5. An LCD device, comprising: a front frame, and a rubber frame; wherein an LCD panel is clamped between said front frame and said rubber frame, and said LCD panel is fixed by said rubber frame in the direction parallel to the light emitting surface thereof, and is clamped and fixed by said front frame and said rubber frame in the direction perpendicular to the light emitting surface thereof; said front frame is in a plate shape.

6. The LCD device of claim 5, wherein said front frame comprises four independent subordinate front frames; said four subordinate front frames form a rectangle front frame end to end.

7. The LCD device of claim 5, wherein said rubber frame is of a structure which is integratedly molded.

8. The LCD device of claim 5, wherein the edge of said front frame is positioned inside the top of said rubber frame, and the top of said rubber frame is flush with the outer surface of said front frame.

9. The LCD device of claim 5, wherein said front frame and said rubber frame are made of the same material.

10. The LCD device of claim 5, wherein said LCD device comprises a backplane; said backplane is provided with a folding surface in the direction of said front frame, and said front frame, said rubber frame and the folding surface of said backplane are fixed by a screw;
and the outer surface of said front frame is provided with a sinking surface in the fixing position of said screw.

11. The LCD device of claim 10, wherein the inner surface of said front frame facing said LCD panel is provided with an inner sinking surface.
